(19) United States
(12) Patent Application Publication
(10) Pub. No.: US 2012/0163598 A1
(43) Pub. Date: Jun. 28, 2012

(54) SESSION SECURE WEB CONTENT DELIVERY

(75) Inventors: Hualin Wang, San Jose, CA (US); Yang-cheng Fan, San Jose, CA (US)

(73) Assignee: SAP AG, Walldorf (DE)

(21) Appl. No.: 12/975,738

(22) Filed: Dec. 22, 2010

(51) Int. Cl. H04L 9/12

(52) U.S. Cl. 380/259

(57) ABSTRACT

Various embodiments herein include one or more of systems, methods, and software to provide session secure web content delivery. Some embodiments include initiating a session on a web server in response to a resource request received from a requestor and generating a session key that is in scope with regard to and during the session. Such embodiments may also include retrieving the requested resource, identifying and encrypting Uniform Resource Identifiers (URI's) included therein, and sending the requested resource including encrypted URI's to the requestor. Some embodiments may include receiving, within the scope of a session, a resource request including a URI having a cipher text. Such embodiments may then decrypt the cipher text utilizing a key of the session as the decryption key to obtain clear text. The cipher text of the URI may then be replaced with the clear text and the resource retrieved and sent to the requestor.

### BACKGROUND INFORMATION

Web content delivery systems today can create security vulnerabilities. For example, a Universal Resource Identifier (URI), such as a Universal Resource Locator (URL), of a server may be exposed within content readily accessible via the Internet. This information may be obtained and exploited for nefarious purposes, thereby contributing to security vulnerabilities.

Further, it is common for users to copy a URL and share it with another user. However, in some systems with a low security standard, user credentials may be required to access certain content, but the user credentials only provide access to a set of URL's for content that is otherwise not secured. Thus, sharing of a URL accessed after providing user credentials allows unauthorized users to access privileged content.

### BRIEF DESCRIPTION OF THE DRAWINGS

FIG. 1 is a block diagram of a system according to an example embodiment.

FIG. 2 is a block flow diagram of a system according to an example embodiment.

FIG. 3 is a block flow diagram of a method according to an example embodiment.

FIG. 4 is a block flow diagram of a system according to an example embodiment.

FIG. 5 is a block flow diagram of a method according to an example embodiment.

FIG. 6 is a block diagram of a computing device according to an example embodiment.

### DETAILED DESCRIPTION

Currently, there are two popular web content delivery models. One model is to publish the absolute URI to web page directly. The other is to dynamically generate a placeholder URI and a dedicated service is used to deliver the web content stream to the end user. For example, to display an image on a webpage, a static URI model web page source could look like
<img src=http://l.yimg.com/a/i/ww/news/2010/06/09/tower.jpg height=“250” width=“150”>

A dynamic URI model web page source could look like
<img src=“/servlet/Image?ID=12345” height=“150” width=“125”>

For the static model, the user can easily figure out on which server and in which folder the image or other content is stored. There are at least two drawbacks of this model. First, the file server can easily be a vicious attack target. Second, the user can pass around the file URI to other people, without carefully security measure, the unauthorized user can access the web content which is not intended.

For the dynamic model, the web content URI is hidden from the user. This is a bit more secure than the static model. However, for the users who have the access right to the dedicated service, they still can share the dynamic URI placeholder. For example, user A and user B both work in the same company and both have access to the web server. User A can view image
<img src=“/servlet/Image?ID=1” height=“150” width=“125”>
   User B can view image:
<img src=“/servlet/Image?ID=2” height=“150” width=“125”>.
   During the logon, based on the roles the users have, it is decided that user A is only supposed to access image ID=1, user B is only supposed to access image ID=2. In such instances, the security check is performed at the logon level and not performed at the servlet level, user A and user B can pass the image URI to each other and both can access the two images. At the same time, performing a security check at the servlet level can be a very expensive operation in terms of utilization of computing resources.

Various embodiments illustrated and described herein provide mechanism that hides portions of URI's outside of the computing environment of a content host. Some such embodiments include a dedicated service, such as a servlet or other module, which utilizes a session key that is generated and accessible by the servlet only within the scope of a session. The session key is utilized by the dedicated service to encrypt portions of URI's to hide information that would otherwise be revealed within the URI. The unencrypted portions of the URI include at least enough information for a request to be routed back to a proper web server. When a request, such as a request for an image, is subsequently received and reaches the dedicated service, the same session key is used to decrypt the URI. Then the correct web content will be delivered to the requestor. As a result, sharing a URI with an encrypted portion received within a different session results in an unresolvable URI as the proper session is not be available to perform the decryption operation. Further, the naming and addressing of resources within the computing environment of the host will not be visible to the outside.

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, Application Specific Integrated Circuit (ASIC), microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

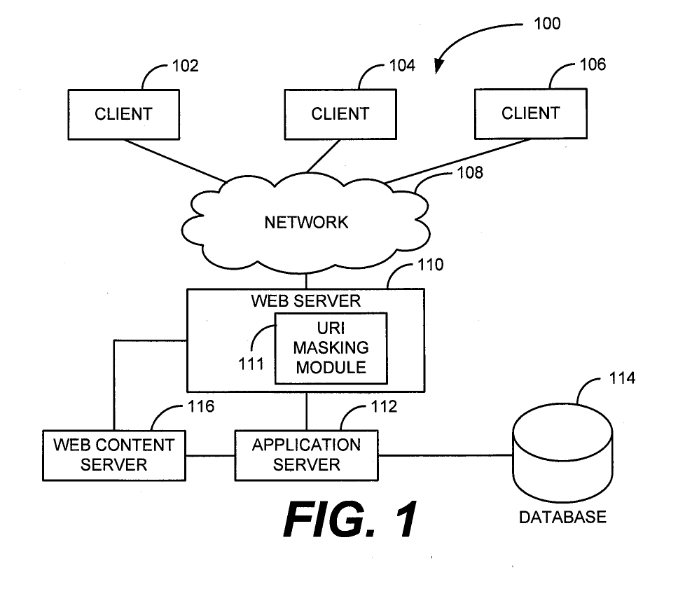

FIG. 1 is a block diagram of a system 100 according to an example embodiment. The system 100 includes client computer 102, 104, 106 connected to a network 108. Also connected to the network 108 is a web server 110. Connected to the web server, typically via another network such as a local area network (LAN) or system area network (SAN), are a web content server 116 and an application server 112. The application server 112 and potentially other components of the system 100 may also be connected to a database 114 that is under management of a database management system (DBMS).

The clients 102, 104, 106 may include one or more of personal computers, processes executing on a computing device or machine such as a server, a handheld computer, a smart phone, a set top box (STB), a television, or other device capable of executing instructions on a processor, ASIC, or other circuit. The clients request content from the web server 110 through use of URI's submitted to the web server 110 over the network 108. The network 108 may include one or more of the Internet, a LAN, a SAN, a wide area network (WAN), a virtual private network (VPN), a value added network (VAN), and the like. The clients 102, 104, 106 and web server 110 may communicate with the network via one or more of wired and wireless networks.

The web server 110 includes a URI masking module 111. The URI masking module 111, in some embodiments, is a software process that executes on at least one processor of a server computer or server computer cluster providing web server functionality. Such web server functionality includes receiving requests via the network 108 and delegating, delegating in part and responding in part, or responding to the received requests. The URI masking module 111 typically performs two functions which may be included in distinct modules within the URI masking module 111. The two functions include a URI masking function and a URI demasking function. The masking and demasking functions serve to limit use of a URI to a particular requestor during a particular communication session. For example, when the web server 110 receives a request via the network 108 from one of the client 102, 104, 106, the web server 110 initiates a session with regard to the request and generates a unique session key that is in scope only within and during that session. The masking portion of the URI masking module 111 then uses that session key to encrypt at least a portion of at least some URI's included in content returned to the requesting client 102, 104, 106. Subsequently, when a URI including an encrypted portion is received, the demasking portion of the URI masking module 111 decrypts the encrypted portion and replaces the encrypted, cipher text portion of the URI with the decrypted, clear text. The URI is then processed by the web server 110 as it would be normally. However, prior to content being returned to the requesting client 102, 104, 106 once more, the URI masking module 111 may again evaluate the content to be returned to the requesting client 102, 104, 106 to encrypt any particular URI's included within the content. Further detail as to the operation of the URI masking module 111 is provided with reference to the following figures.

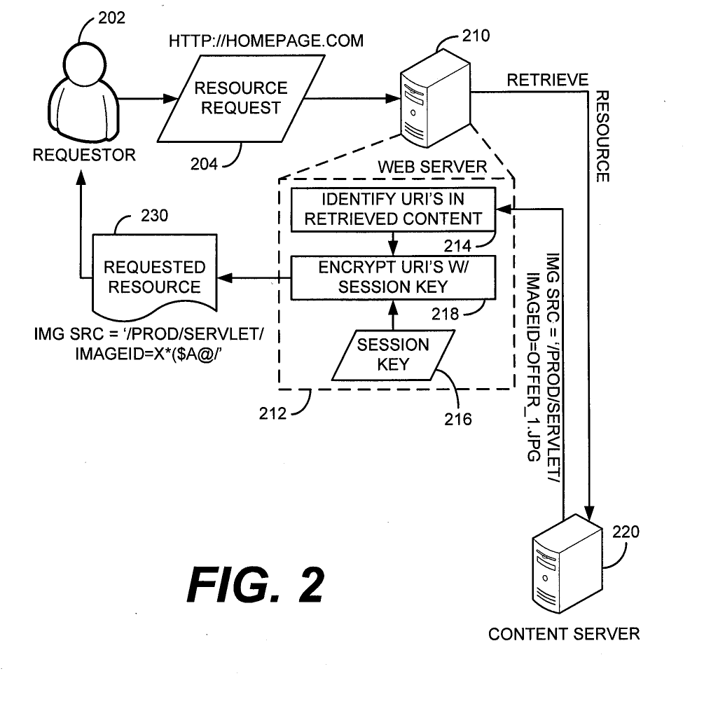

FIG. 2 is a block flow diagram of a system according to an example embodiment. The system includes a requestor 202 that may be a human or logical user that submits a resource request 204 over a network, such as network 108 of FIG. 1. The resource request 204 in the illustrated embodiment of FIG. 2 is for a web page encoded in a markup language at a URL http://homepage.com/index.html which includes an image offer_{—}1.jpg. The requestor 202 submits the resource request 204 over the network to a web server 210.

The web server 210 may be the same web server 110 of FIG. 1 or may differ. Generally, web server 210 is a process that executes on one or more or one or more clusters of physical computing devices that may be co-located or disbursed over a vast geographic area. The web server 210 operates to receive resource requests via a network, such as the Internet, and to respond with the requested resource, such as a web page, image, file, multimedia content, a document, or other resource. The web server 210 may receive the resource requests via one or more protocol requests, such as Hypertext Transfer Protocol (HTTP) or others such as Internet Message Access Protocol (IMAP) or the File Transfer Protocol (FTP).

Upon receipt of the resource request 204, the web server 210 assigns a session key 216, which may also be referred to as a session identifier. The web server then retrieves the resource request from a location where the requested resource is stored, such as content server 220. The web server 210 then receives the requested content, which in the illustrated embodiment of FIG. 2 is a web page. The web page includes an image reference within the markup language that will also be requested by a web browser application of the requestor 202 once the web page is received by the web browser. For example, the image reference may be “IMG SRC=‘/PROD/SERVLET/IMAGEID=OFFER_{—}1.JPG”, However, the web server 210, prior to sending the requested resource 204 to the requestor 202, first routes the retrieved web page to a URI masking module 212.

The URI masking module 212 operates to identify 214 URI's within retrieved content, such as the web page retrieved from the content server 220. In this instance, the URI masking module identifies the URI “IMG SRC=‘/PROD/SERVLET/IMAGEID=OFFER_{—}1.JPG”. The URI masking module 212 then encrypts 218 a portion of the identified URI's according to an encryption algorithm using the session key 216 as a synchronous encryption key. For example, the identified URI becomes “IMG SRC=‘/PROD/SERVLET/IMAGEID=X*($A@/’”

The portion encrypted may be identified based on a configuration setting. Generally, a portion of the URI may not be encrypted to ensure the URI is still functional when used by the requestor 202 to request a respective resource. For example, if the web server is at “http://homepage.com”, that portion may not be encrypted. The remaining portions of the URI may be encrypted though. The potion that may not be encrypted is the portion needed to route a request to a proper web server or other network resource including a URI masking module 212 and having or having access to the session key 216. The encryption algorithm utilized could be virtually any encryption algorithm, such as any of the PGP, RSA, DES/3DES, IDA, SEAL encryption algorithms.

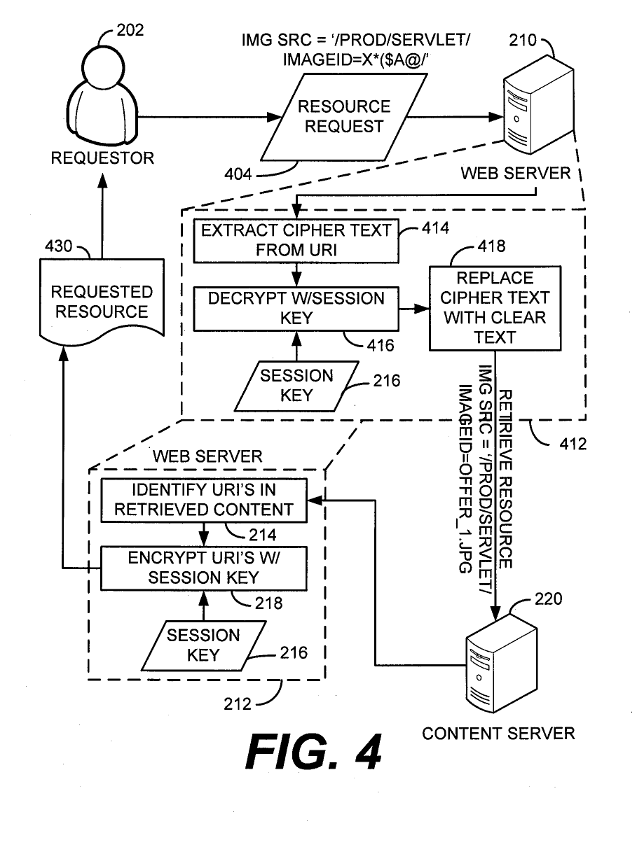

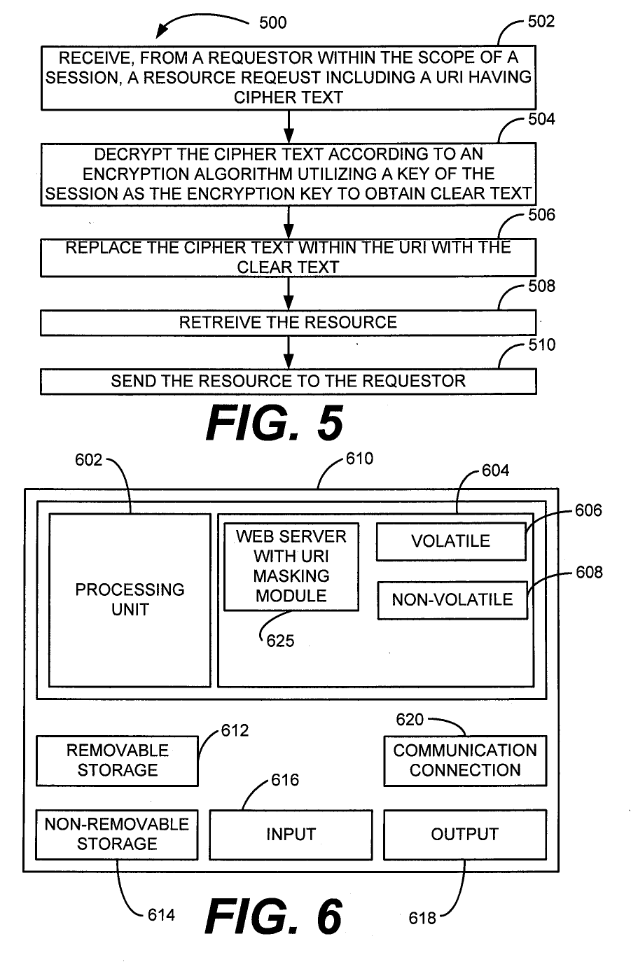

The portions of the URI's that are encrypted are then replaced in the retrieved resource and the requested resource 230 is then sent to the requestor 202. Later, when the URI with the encrypted portion is requested and received by the web server 210, the same session key 216 is utilized to decrypt the cipher text of the URI to obtain clear text. Further detail such as processing of resource requests to URI's including cipher text are described below with regard to FIG. 4 and FIG. 5.

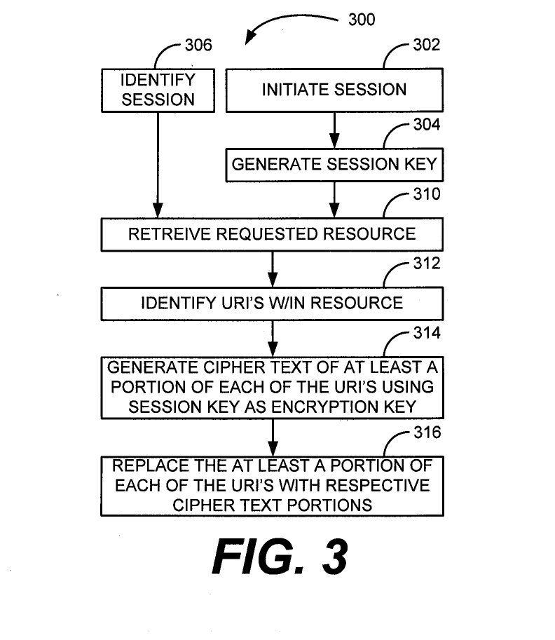

FIG. 3 is a block flow diagram of a method 300 according to an example embodiment. The method 300 illustrated in the embodiment of FIG. 3 is an example of a method that may be performed by a web server including a URI masking module upon receipt of a resource request.

The method 300 may be performed in software and executed by a processor, such as a general-purpose processor or ASIC. In other embodiments, all or a portion of the method 300 may be performed by a hardware circuit with encoded logic in firmware and an ASIC for the specific purpose of at least in part performing the method 300.

In some embodiments of the method 300, a request from a requestor is first processed to determine if the resource request is part of an existing session on the web server. When the request is part of an existing session, the method 300 includes identifying 306 the session. When the request is not part of a session, the method 300 includes initiating 302 a session and generating a session key 304. Whether a session was identified 306 or initiated 302, at this point the method 300 includes retrieving 310 a requested resource identified in the resource request. Next, the method 300 typically includes processing the retrieved 310 resource to identify 312 URI's included within the resource. Such URI's may be image references when the resource is a web page or other document type, such as a page description language document (i.e., PDF), that may include embedded images and multimedia (i.e., mp3 files with music or speech, various video file types, etc.) content by reference to a URI. The URI's may also include hyperlinks within the web page or another reference type. In some embodiments, identifying 312 the URI's within the resource includes identifying 312 URI's that meet one or more rules or configuration settings as specified by a user, an administrator, a policy, or other person or setting. Such rules may designate specific URI's, one or more particular markers in a markup language, network addresses, IP addresses, server, servlet, or other resources that are to be identified 312 or ignored.

Once the URI's are identified 312, the method 300 includes generating 314 cipher text of at least a portion of each of the identified 312 URI's using the session key as an encryption key. The portion of each of the identified 312 URI's to be encrypted may be specified in the one or more rules or configuration settings as discussed above. At a minimum though, the portion of a URI that remain as clear text is a portion sufficient to route a request using the URI to an appropriate web server including or having access to a URI masking module and the appropriate session key. The encrypted portion of each identified 312 URI is then replaced 316 with respective cipher text portions. The requested resource may then be provided to the requestor.

FIG. 4 is a block flow diagram of a system according to an example embodiment. The system includes the requestor 202 and web server 210 illustrated and described with regard to FIG. 2. In the embodiment illustrated in FIG. 4, the requestor submits a resource request 404 to a URI that includes a cipher text portion. As illustrated, the cipher text portion is:
‘/PROD/SERVLET/IMAGEID=X*($A@/’”.
   This is the cipher text as illustrated and described with regard to FIG. 2.

In the embodiment of FIG. 4, the web server 210 includes the URI masking module 212 and a URI demasking module 412. Thus, when the web server 210 receives the resource request 404, the URI is evaluated to determine if it includes an encrypted, cipher text portion. When an encrypted portion is included in the resource request 404, the web server 210 routes at least the URI of the resource request 404 to the URI demasking module 412.

The URI demasking module 412 begins by extracting 414 the cipher text from the URI. The cipher text is then decrypted 416 with the session key 216 to obtain clear text. The URI demasking module 412 then replaces 418 the cipher text of the URI with the clear text. The URI demasking module 412 may then return the URI to the web server 210 or cause the resource of the resource request 404 to be retrieved, such as from the content server 220.

In some embodiments, when the requested resource is retrieved from the content server 220, the resource is then processed by the URI masking module to determine if there are any URI's included in the resource. If there are none or at least no URI's in need of masking, the requested resource 430 may then be sent to the requestor 202. However, if there are URI's in need of making, the URI making module identifies 214 the URI's in the retrieved content and then encrypts 218 portions of the URI's with the session key 216 to obtain cipher text as discussed above with regard to FIG. 2. The identified 214 URI's within the resource are then modified to replace the portions of clear text with cipher text. The modified requested resource 430 is then returned to the requestor.

FIG. 5 is a block flow diagram of a method 500 according to an example embodiment. FIG. 5 illustrated an example embodiment of a method 500 to handle resource requests received by a web server that include cipher text. The method 500 may be performed in software and executed by a processor, such as a general-purpose processor or ASIC. In other embodiments, all or a portion of the method 500 may be performed by a hardware circuit with encoded logic in firmware and an ASIC for the specific purpose of at least in part performing the method 500.

The example method 500 includes receiving 502, within the scope of an existing session on a web server, a resource request including a URI having a cipher text. The method 500 may then decrypt 504 the cipher text according to an encryption algorithm utilizing a key of the session as the encryption key to obtain clear text. Next, the method 500 includes replacing 506 the cipher text within the URI of the resource request with the clear text. Some embodiment of the method 500 may then retrieve 508 the resource utilizing the URI modified to include the clear text and then sending 510 the second resource to the requestor.

In some such embodiments, prior to sending 510 the resource to the requestor, the method 500 may further include identifying URI's included within data of the resource, if there are any. When there are URI's the method 500 in such embodiments includes generating cipher text for at least a portion of each of the identified URI's within data of the resource according to the encryption algorithm and utilizing the session key as the encryption key. Next, the method 500 may include replacing portions of the identified URI's with respective portions of cipher text.

FIG. 6 is a block diagram of a computing device according to an example embodiment. In one embodiment, multiple such computer devices are utilized in a distributed network to implement multiple components in a web server environment. An object-oriented, service-oriented, or other architecture may be used to implement such functions and communicate between the multiple computer devices, systems, and components. One example computing device in the form of a server computer 610, may include at least one processing unit 602, at least one memory 604, at least one removable storage 612, and at least one non-removable storage 614. The at least one memory 604 may include volatile memory 606 and non-volatile memory 608. The server computer 610 may include—or have access to a computing environment that includes—a variety of computer-readable media, such as volatile memory 606 and non-volatile memory 608, removable storage 612 and non-removable storage 614. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Server computer 610 may include or have access to a computing environment that includes input 616, output 618, and a communication connection 620. The server computer 610 typically operates in a networked environment using a communication connection to connect to one or more remote computers, such as database servers, client computers, content servers, and the like. The one or more remote computers may also include a personal computer (PC), server, router, network PC, a peer device or other common network node, and the like. The communication connection may include a Local Area Network (LAN), a Wide Area Network (WAN), the Internet, and other networks.

Computer-readable instructions stored on a computer-readable medium are executable by the at least one processing unit 602 of the computer server 610. A hard drive, CD-ROM, and RAM are some examples of articles including a computer-readable medium upon which a computer program maybe encoded and stored. For example, instructions executable by the at least one processing unit 602 of a computer program of a web server with a URI making module 625 capable of performing all or portions of the embodiments described herein may be stored on a computer-readable medium.

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A method comprising:
initiating a session on a web server in response to a resource request received from a requestor;
generating a session key that is in scope with regard to and during the session;
retrieving the requested resource;
identifying Uniform Resource Identifiers (URI's) included within data of the requested resource;
generating cipher text for at least a portion of each of the identified URI's according to an encryption algorithm utilizing the session key as an encryption key;
replacing at least the portion of the identified URI's within the retrieved requested resource with respective cipher text; and
sending the requested resource including the cipher text to the requestor.

2. The method of claim 1, further comprising:
receiving, within and during the scope of the session, a second resource request including a URI having a cipher text;
decrypting the cipher text according to the encryption algorithm utilizing the session key as the decryption key to obtain clear text;
replacing the cipher text within the URI of the second resource request with the clear text;
retrieving the second resource according the URI of the second resource with the clear text; and
sending the second resource to the requestor.

3. The method of claim 2, wherein prior to sending the second resource to the requestor, the method further comprises:
identifying URI's included within data of the second resource, if any; and
when URI's are identified as being included within data of the second resource:
generating cipher text for at least a portion of each of the identified URI's within data of the second resource according to the encryption algorithm utilizing the session key as the encryption key; and
replacing the at least a portion of the identified URI's within the retrieved second resource with respective cipher text.

4. The method of claim 2, wherein the second resource is an image file.

5. The method of claim 1, wherein the generating of the cipher text for at least a portion of each of the identified URI's includes not encrypting a portion of the URI sufficient to allow routing of a request utilizing the URI to a proper network location.

6. The method of claim 1, wherein:
the requested resource is a file including textual data encoded in a markup language; and
identifying URI's included within data of the requested resource consists of identifying URI's associated with at least one particular marker of the markup language.

7. The method of claim 6, wherein identifying URI's included within data of the requested resource consists of identifying URI's associated with at least one particular marker of the markup language further consists of identifying only URI's of particular network addresses.

8. A non-transitory computer-readable storage medium with instructions stored thereon, which when executed by at least one computer processor of at least one computer, causes the at least one computer to:
initiate a session on a web server in response to a resource request received from a requestor;
generate a session key that is in scope with regard to and during the session;
retrieve the requested resource;
identify Uniform Resource Identifiers (URI's) included within data of the requested resource;
generate cipher text for at least a portion of each of the identified URI's according to an encryption algorithm utilizing the session key as an encryption key;
replace at least the portion of the identified URI's within the retrieved requested resource with respective cipher text; and
send the requested resource including the cipher text to the requestor.

9. The non-transitory computer-readable storage medium of claim 8, with further instructions stored thereon, which when executed by the at least one computer processor of the at least one computer, causes the at least one computer to:
receive, within and during the scope of the session, a second resource request including a URI having a cipher text;
decrypt the cipher text according to the encryption algorithm utilizing the session key as the decryption key to obtain clear text;
replace the cipher text within the URI of the second resource request with the clear text;
retrieve the second resource according the URI of the second resource with the clear text; and
send the second resource to the requestor.

10. The non-transitory computer-readable storage medium of claim 9, wherein the instructions when executed, prior to sending the second resource to the requestor, the instructions are further executed by the at least one computer processor to cause the at least one computer to:
identify URI's included within data of the second resource, if any; and
when URI's are identified as being included within data of the second resource:
generate cipher text for at least a portion of each of the identified URI's within data of the second resource according to the encryption algorithm utilizing the session key as the encryption key; and
replace the at least a portion of the identified URI's within the retrieved second resource with respective cipher text.

11. The non-transitory computer-readable storage medium of claim 9, wherein the second resource is an image file.

12. The non-transitory computer-readable storage medium of claim 8, wherein the requested resource is a web page.

13. The non-transitory computer-readable storage medium of claim 8, wherein:
the requested resource is a file including textual data encoded in a markup language; and
identifying URI's included within data of the requested resource consists of identifying URI's associated with at least one particular marker of the markup language.

14. The non-transitory computer-readable storage medium of claim 13, wherein identifying URI's included within data of the requested resource consists of identifying URI's associated with at least one particular marker of the markup language further consists of identifying only URI's of particular network addresses.

15. A system comprising:
at least one processor;
at least one memory device;
a network interface device;
a Uniform Resource Identifier (URI) masking module stored in the at least one memory device and executable by the at least one processor to:
receive a resource request and a session identifier from a web server with regard to a session initiated on the web server in response to receipt of the resource request by the web server via the network interface device from a requestor;
generate a session key that is in scope with regard to and during the web server session;
retrieve the requested resource;
identify URI's included within data of the requested resource;
generate cipher text for at least a portion of each of the identified URI's according to an encryption algorithm utilizing the session key as an encryption key;
replace at least the portion of the identified URI's within the retrieved requested resource with respective cipher text; and
send the requested resource including the cipher text to the web server.

16. The system of claim 15, wherein the URI masking module is further executable by the at least one processor to:
receive a second resource request from the web server with regard to the session, the second resource request including a URI having a cipher text;
decrypt the cipher text according to the encryption algorithm utilizing the session key as the decryption key to obtain clear text;
replace the cipher text within the URI of the second resource request with the clear text;
retrieve the second resource according the URI of the second resource with the clear text; and
send the second resource to the web server.

17. The system of claim 16, wherein prior to sending the second resource to the web server, the URI masking module is further executable by the at least one processor to:
identify URI's included within data of the second resource, if any; and
when URI's are identified as being included within data of the second resource:
generate cipher text for at least a portion of each of the identified URI's within data of the second resource according to the encryption algorithm utilizing the session key as the encryption key; and
replace the at least a portion of the identified URI's within the retrieved second resource with respective cipher text.

18. The system of claim 15, wherein the requested resource is a web page.

19. The system of claim 15, wherein:
the requested resource is a file including textual data encoded in a markup language; and
identifying URI's included within data of the requested resource consists of identifying URI's associated with at least one particular marker of the markup language.

20. The system of claim 19, wherein identifying URI's included within data of the requested resource consists of identifying URI's associated with at least one particular marker of the markup language further consists of identifying only URI's of particular network addresses.
